(19) United States
(12) Patent Application Publication
(10) Pub. No.: US 2009/0145023 A1
(43) Pub. Date: Jun. 11, 2009

(54) Artificial cultivating method of fruiting body of antrodia camphorata

(75) Inventors: His-Hisung Huang, Yongkang City (TW); Chia-Hsin Huang, Yongkang City (TW)

Correspondence Address: BACON & THOMAS, PLLC, 625 SLATERS LANE, FOURTH FLOOR, ALEXANDRIA, VA, 22314-1176, US

(73) Assignees: His-Hisung HUANG, Yongkang City (TW); Chia-Hsin HUANG, Yongkang City (TW); Kuo-Yang LEE, Yunlin County (TW); Hsiang-Shun CHEN, Nantou County (TW); Hui-Lan LIN, Yongkang City (TW)

(21) Appl. No.: 12/292,917

(22) Filed: Dec. 1, 2008

(30) Foreign Application Priority Data
Nov. 30, 2007 (TW) 096145802

(51) Int. Cl. A01G 1/04

(52) U.S. Cl. 47/1.1

(57) ABSTRACT

The present invention relates to an artificial cultivating technique of fruiting body of Antrodia camphorate. The method concludes a process for cultivating Antrodia camphorata on camphor tree, which comprises liquid culture of Antrodia camphorata, treatment of camphor tree, and useage of essential oil, to cultivate Antrodia camphorata on the segmental woods of camphor tree. The efficiency of successful cultivation is confirmed by micrescopy and HPLC analysis, and compared with that of natural growth.

### FIELD OF THE INVENTION

The present invention relates to an artificial cultivating technique of fruiting body of Antrodia camphorata. In particular, the present invention relates to a cultivating process for growing Antrodia camphorata on the segmental woods of camphor trees and/or other trees.

### BACKGROUND OF THE INVENTION

Until now, Antrodia camphorata is cultured in liquid suspension, or on solid culture media. It is unstable and easy to fail in direct inoculating on segmental woods, and may be contaminated during the growing period.

According to the technique of this invention, the efficiency of successful cultivation is stable and can reach to almost 90%.

### SUMMARY OF THE INVENTION

The present cultivating process of fruiting body of Antrodia camphorata of the invention is based on the fact that A. camphorata can grow on aromatic camphor trees, such as the stem of Cinnamomum kanehirai Hay (Lauraceae).

According to the present cultivating process, plants of Lauraceae, needle-leaved trees, or broad-leaved trees may be used as culture media for A. camphorata.

### BRIEF DESCRIPTION OF THE DRAWINGS

FIG. 1 is a representation of the practice for growing yellow Antrodia camphorata mycelia on PDA medium.

FIG. 2 shows the technique of invention for cultivating A. camphorata on segmental woods of cowcamphor tree in sterilizing bag.

FIG. 2-1 shows the technique of invention for cultivating A. camphorata on segmental woods of cowcamphor tree in sterilizing bag.

FIG. 3 shows the A. camphorata cultivated on segmental wood of cowcamphor tree.

FIG. 4 is a representation of fruiting body of A. camphorata after one-year culture by the process of present invention, in which the porous tubes and red fruiting bodies are observed.

FIG. 5 is a representation of porous non-vertical tubes (one-year cultivation) observed under 45× seteromicroscopy.

FIG. 6 is a representation of porous non-vertical tubes (one-year cultivation) observed under 180× seteromicroscopy.

FIG. 7 is a representation of wild Antrodia camphorata.

FIG. 7-1 is a representation of wild Antrodia camphorata.

FIG. 8 is a representation of porous non-vertical tubes (wild A. camphorata) observed under 45× seteromicroscopy.

FIG. 9 is a representation of porous non-vertical tubes (wild A. camphorata) observed under 180× seteromicroscopy.

FIG. 10 shows the HPLC (High Performance Liquid Chromatography) analysis of the fruiting body of A. camphorata cultured by the process of present invention.

FIG. 11 shows the HPLC (High Performance Liquid Chromatography) analysis of the fruiting body of wild A. camphorata.

FIG. 12 shows the fruiting body of A. camphorata cultivated on aromatic camphor Wood.

FIG. 13 shows the fruiting body of A. camphorata cultivated on aromatic camphor wood for 3 months.

FIG. 14 is a representation of porous non-vertical tubes of A. camphorata (cultivated on aromatic camphor wood for 3 months) observed under 180× seteromicroscopy.

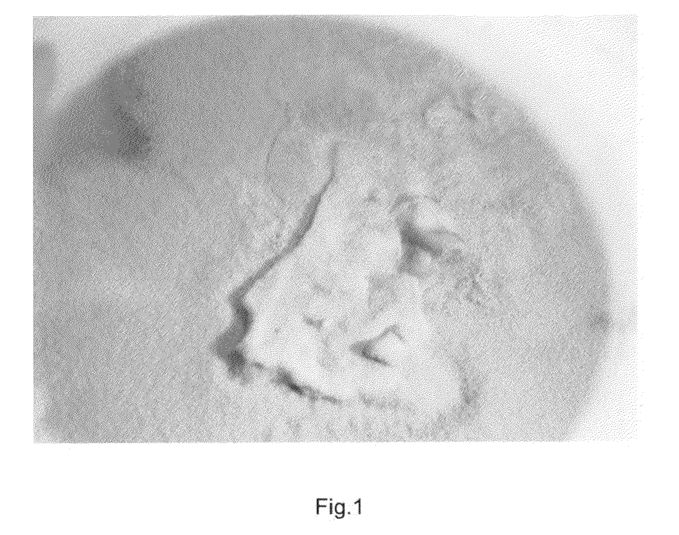

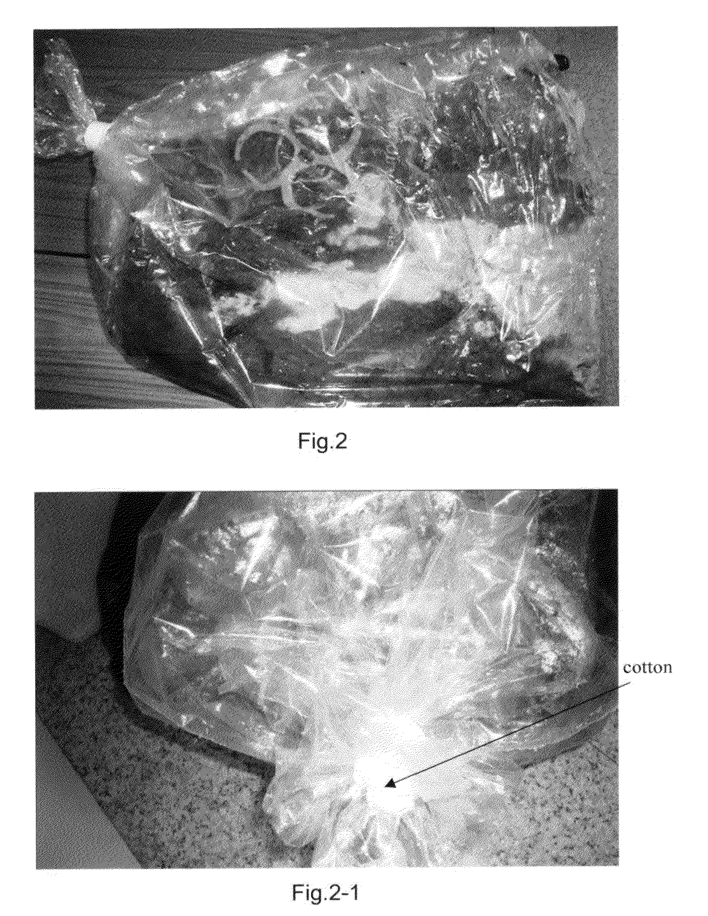

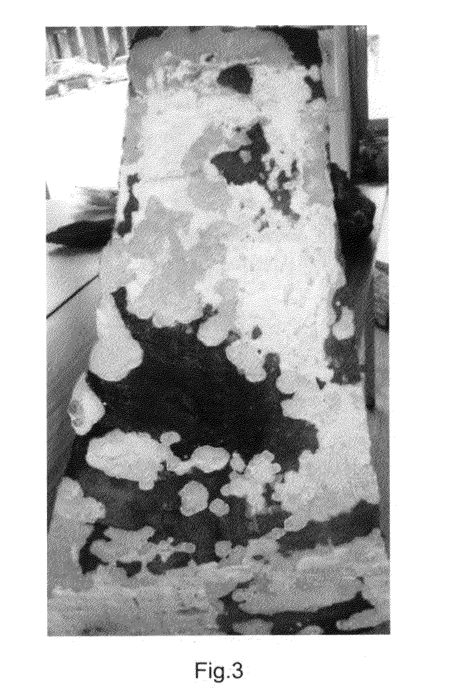

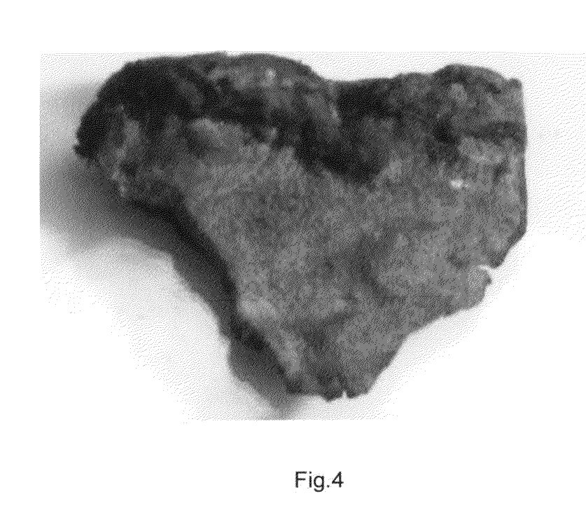

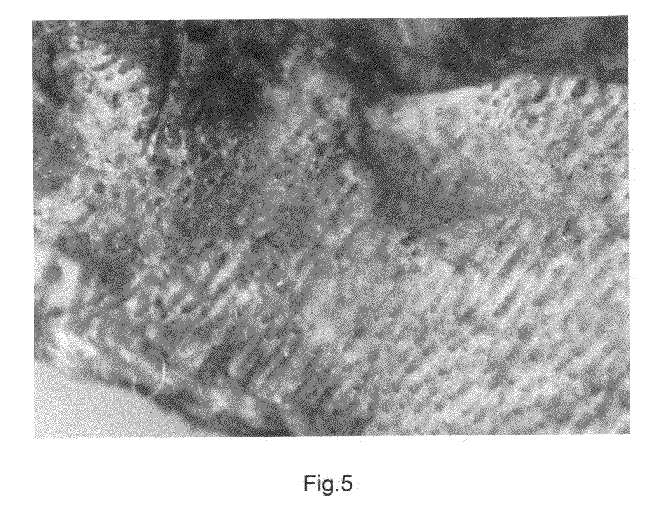

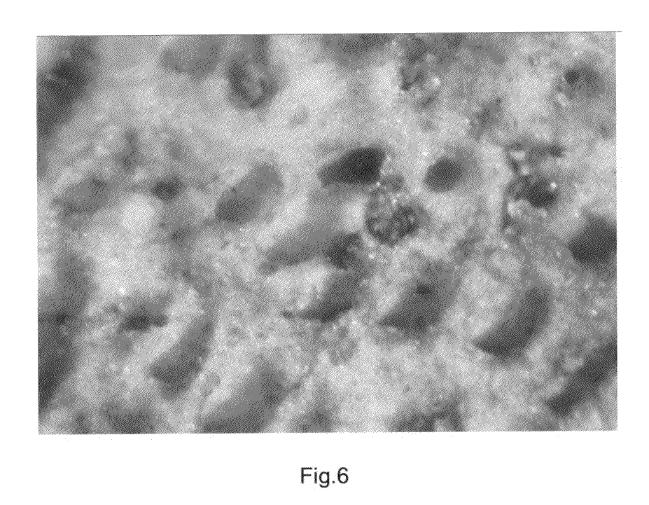

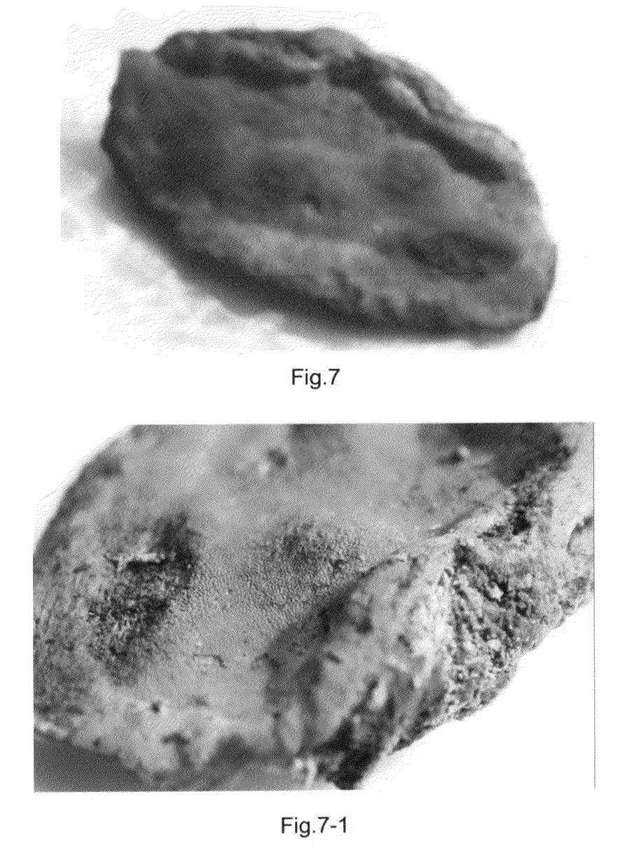

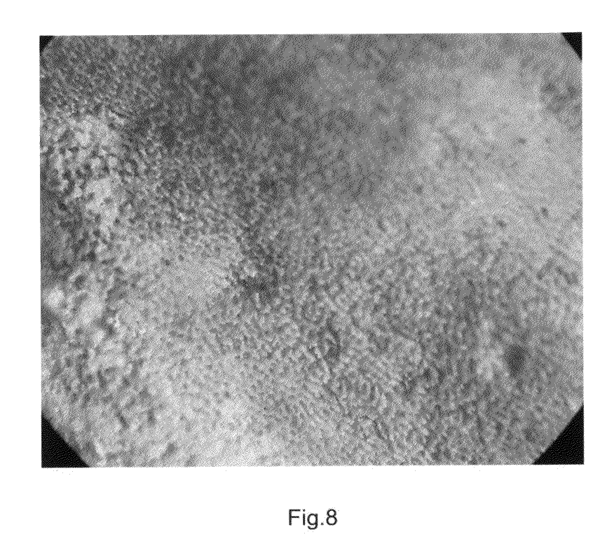

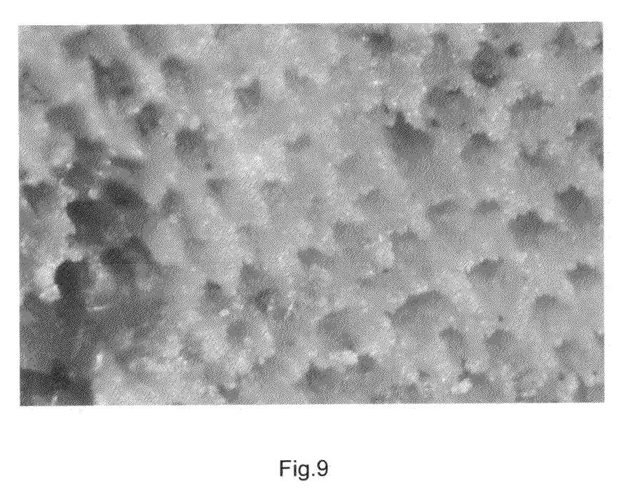

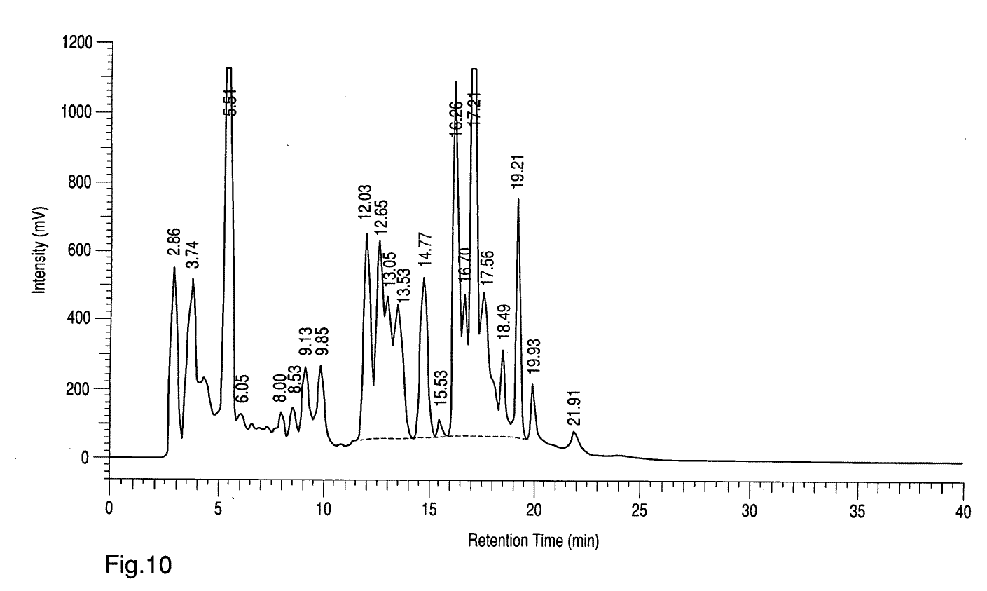

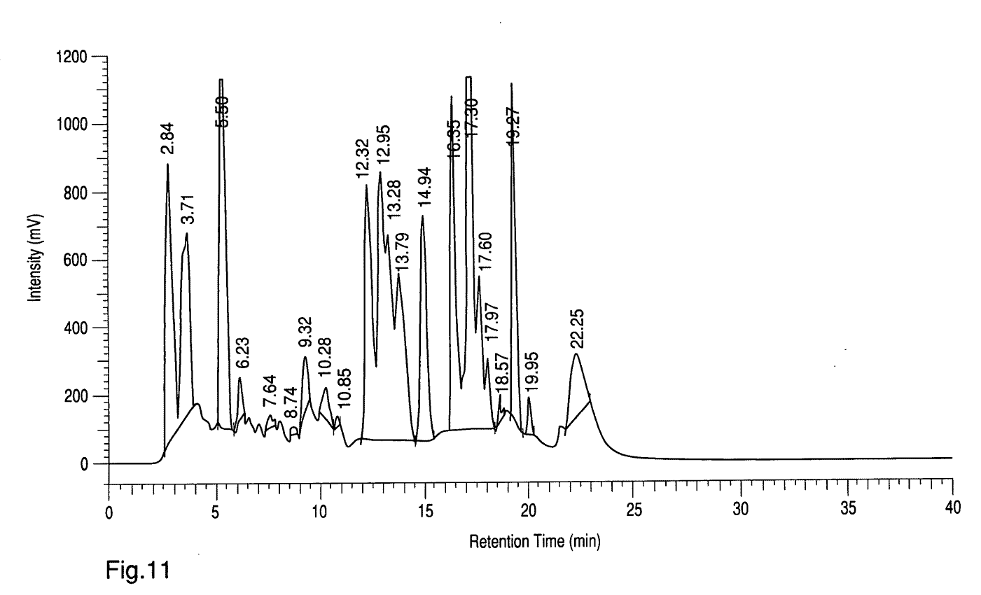

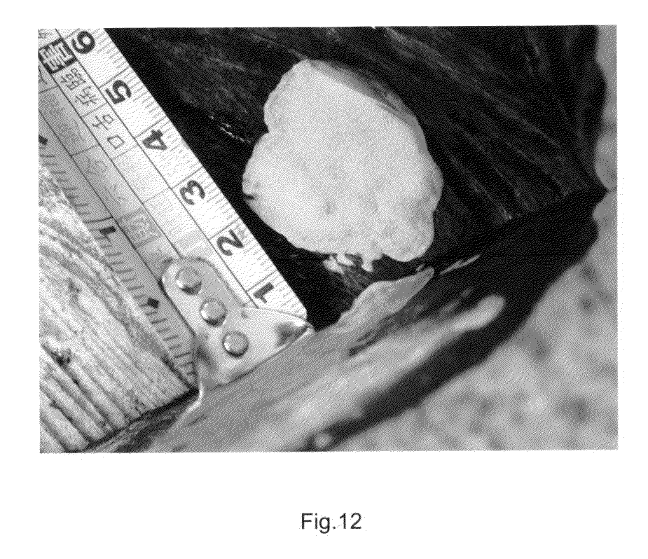

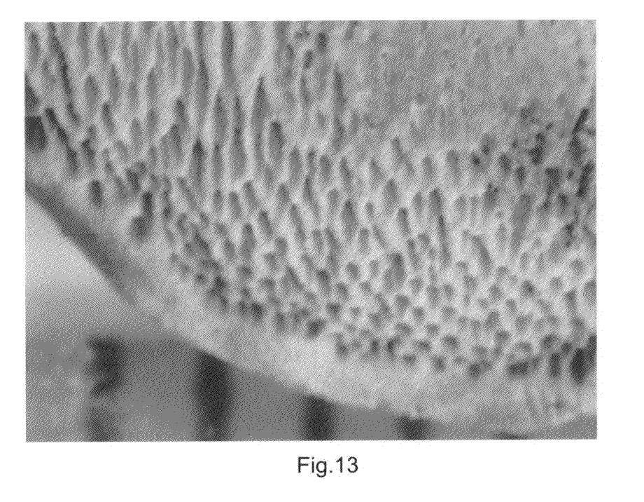

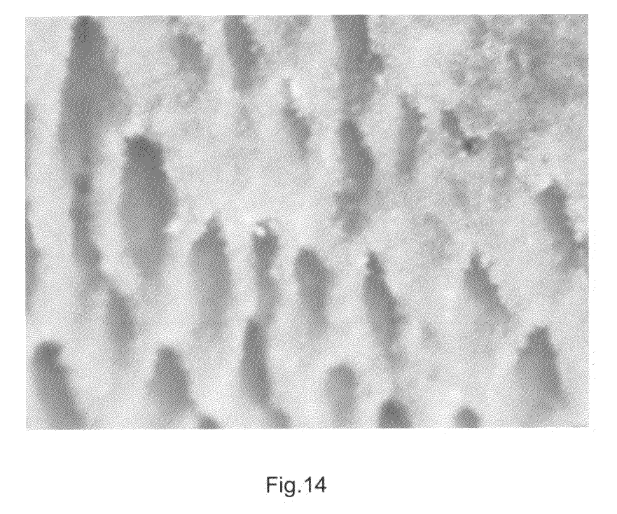

### DETAILED DESCRIPTION OF THE INVENTION

The practicing steps of the invention:
1. wild A. camphorata is chopped and blent with sterile PBS (Phosphate buffer solution), and the mixture is streak plated on PDA (Potato dextrose agar) to isolate single mycelium;
2. enriching cultured in MEB (Malt extract broth) containing 0.1˜2% of essential oil from cowcamphor tree, 0.5˜5% of Myotonin, Glucose 0.5˜5%, Sucrose 0.5˜4%, Peptone 0.05˜3%, Yeast extraction 0.05˜3%, salts 0.01˜0.2% of K₂HPO₄, 0.01˜0.2% of KH₂PO₄.0.01˜0.2% of MgSO₄.7H₂O, 0.01˜3% of camphor oil, at 28° C., 110 rpm for 30 days to obtain a suspension of A. camphorata mycelia;
3. woods of cowcamphor tree, aromatic camphor tree, needle-leaved tree, or broad-leaved tree is cut into segmental woods with the size of 5˜100 cm×10˜120 cm;
4. the segmental woods are sealed in sterilizing bags with cotton inlet, and autoclaved, for example, at 121° C. for 0.5˜12 hours;
5. the suspension of A. camphorata mycelia is spreaded onto surfaces of segmental woods; and,
6. cultured in dark, at temperature of 20˜40° C., humidity above 80% for one year.

The efficiency of successful cultivation by the method of invention is compared with that of natural growth by micrescopy and HPLC analysis.

1. A cultivating process of fruiting body of Antrodia camphorata, which comprises the steps of:
(a) autoclave sterilizing woods or segmental woods of cowcamphor tree, aromatic camphor tree, needle-leaved tree, or broad-leaved tree for 0.5˜12 hours;
(b) attaching the suspension of A. camphorata mycelia obtained by enriching culture onto the woods or segmental woods; and
(c) culture in dark, at temperature of 20˜40° C., humidity above 80%.

2. The cultivating process of claim 1, wherein the MEB and PDA medium in cultures of Antrodia camphorata is added 0.1˜2% of essential oil and nutrient from cowcamphor tree, 0.5˜5% of Myotonin, Glucose 0.5˜5%, Sucrose 0.5˜4%, Peptone 0.05˜3%, Yeast extraction 0.05˜3%, 0.01˜0.2% of K₂HPO₄, 0.01˜0.2% of KH₂PO₄, 0.01˜0.2% of MgSO₄.7H₂O, and 0.01˜3% of camphor oil.

3. The cultivating process of claim 1, wherein the woods or segmental woods are sealed in sterilizing bags.
